(19) United States
(12) Patent Application Publication
(10) Pub. No.: US 2025/0010134 A1
(43) Pub. Date: Jan. 9, 2025

(54) SYSTEM FOR ACQUIRING AND ANALYSING A SPORTS PERFORMANCE

(71) Applicant: MAS-TECH S.R.L., CAVEZZO (IT)

(72) Inventor: DONATO CAMPAGNOLI, SAN POSSIDONIO (IT)

(21) Appl. No.: 18/711,200

(22) PCT Filed: Nov. 17, 2022
(86) PCT No.: PCT/IB2022/061083

§ 371 Date: May 17, 2024

(30) Foreign Application Priority Data
Nov. 19, 2021 (IT) 102021000029321

(51) Int. Cl. A63B 24/00

(52) U.S. Cl. CPC A63B 24/0006; A63B 24/0062

(57) ABSTRACT

The system for acquiring and analysing a sports performance includes an electronic processing unit having a reading module, configured to receive as input a succession of data associated with the execution of the sports performance; a suspension module configured to identify series of actions that conclude with the suspension of play, on the basis of predefined playing rules, wherein each playing action is defined at least by the reciprocal relations between players and the playing projectile coupled with fundamental playing events marking the sports performance, uniquely identified over time and derived from the acquired succession of data; and a segmentation module configured to divide the series of actions into one or more playing segments, each of which includes three actions at most.

The present invention relates to a system for acquiring and analysing a sports performance, such as a match or a training or the like, with special but not exclusive regard to situational sports and in particular to racket sports.

In detail, by way of not limiting example, the invention relates to the acquisition and analysis of a tennis performance.

Sports games are among the most important human activities, both from the point of view of dedication and passion for them and because they are the basis of industries of great economic importance.

For these reasons, the market currently feels the need for systems in order to increase the efficiency of sports performance of those practising them, whether they are professionals, beginners or amateurs.

The technical task underlying the present invention is therefore to propose a system for acquiring and analysing sports performance that satisfies the above-mentioned need.

This technical task is achieved by the system made according to the attached claims.

Further characteristics and advantages of the present invention will become more apparent from the following indicative, and hence non-limiting, description of preferred, but not exclusive, embodiments of the system of the invention, as illustrated in the accompanying drawings, in which:

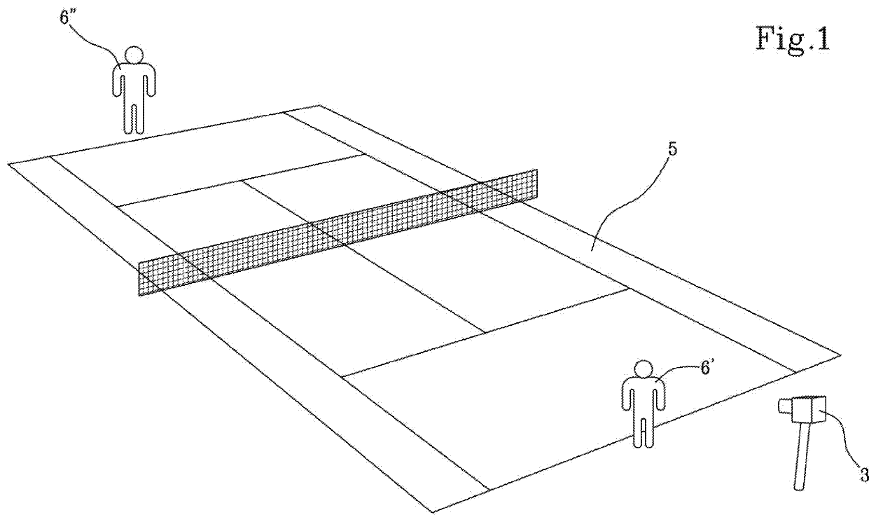

FIG. 1 is a stylized representation of a playing court, filmed by a camera included in the system of the invention;

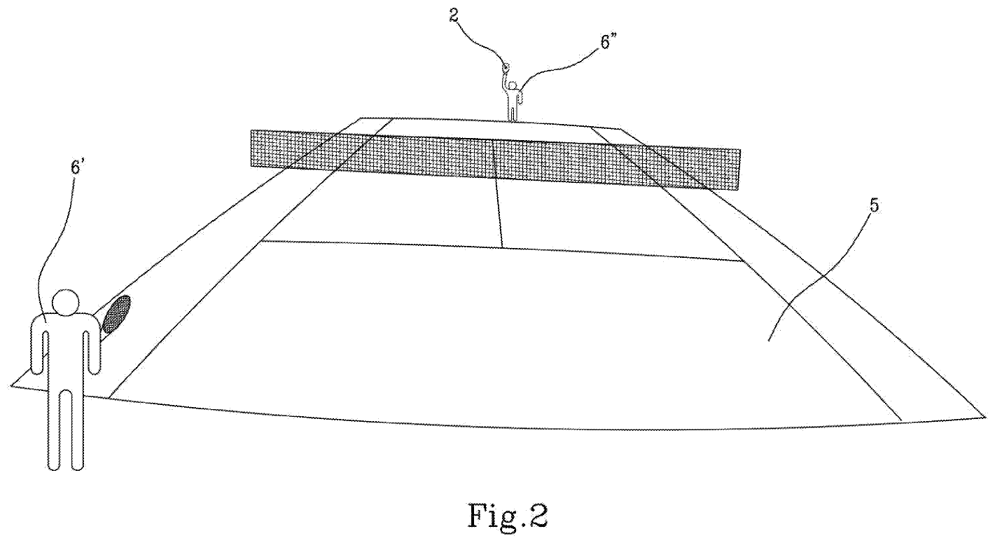

FIGS. 2-5 are stylized representations of different moments of play and

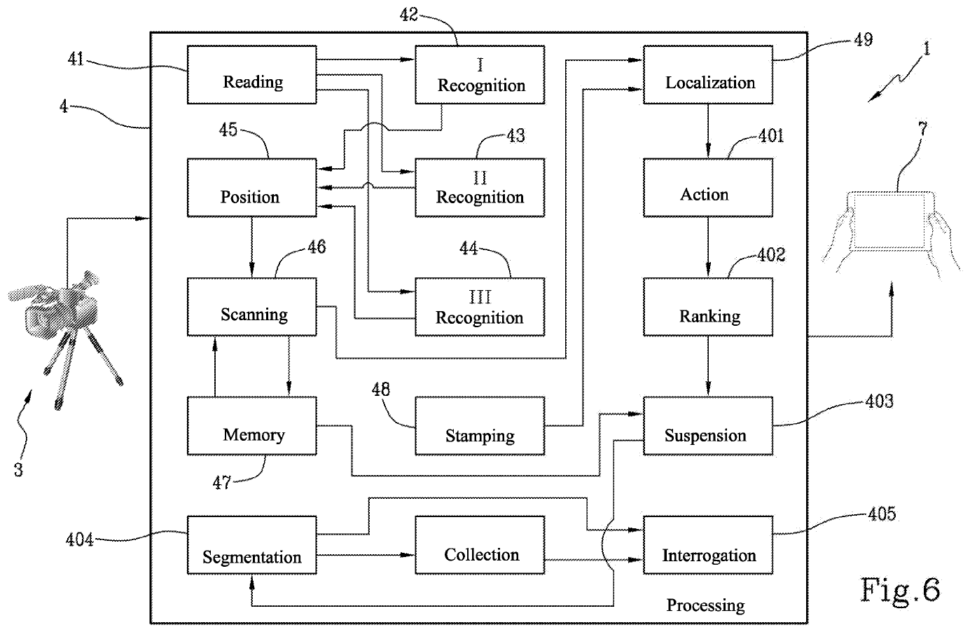

FIG. 6 is a schematic representation of the proposed system, comprising a processing unit of which some of the main functional modules are shown by way of example.

The invention described below is configured as a system for acquiring and analysing 1 a sports performance.

By way of not limiting example, the system 1 is designed to acquire and analyse tennis matches or in any case situational sports performances that preferably involve the use of a ball 2 or other playing projectile.

Hereinafter, for reasons of illustrative simplicity and without this automatically limiting the scope of the invention, we will refer to the case in which the performance acquired and analysed by the system of the invention is a tennis match.

Furthermore, the following description will refer to the preferred, but not limiting, embodiment of the invention devised to acquire video footage of the matches, for example all played by the same tennis player and to analyse them in order to develop a database, from which to extract descriptive, prescriptive and predictive information.

Such information can have multiple uses, such as training the player, both with coach and self-taught, as well as updating the coaches, entertainment or dissemination of the sports discipline.

It is understood that the inventive concept that is expressed in the analysis functions performed by the invention remains valid regardless of what means has been used to acquire the sequence of data characteristic of the matches; in fact, in principle, the same data that can be analysed by the invention could be generated by a multiplicity of acquisition means, including human or manual means, or through the use of GPS or inertial sensors or even optical sensors other than cameras or other means as long as they are suitable for the purpose.

That having been said, in the following we will refer to a system 1 that envisages using at least one electronic device to acquire a video representation 3, that is a video, of each match. Such a device may be a camera 3 or other similar means, of a professional kind or not, not excluding cameras mounted on mobile communication devices, drones, wearable optical acquisition devices, and so on.

The invention then preferably includes memory means in which said video is recorded, which means can be local or remote with respect to the acquisition device 3 and therefore be integrated into it or can be connected to it via a telecommunication network.

The system 1 comprises an electronic processing unit 4, connected to or integrating the aforementioned memory means, which is arranged to analyse the recording.

In general, it should be noted that, in the present description, the processing unit 4 is presented as subdivided into distinct functional modules for the sole purpose of describing the functions thereof in a clear and complete manner.

In practice, this processing unit 4 can also consist of a single electronic device that is suitably programmed to perform the disclosed functions; the different modules can correspond to hardware entities and/or to routine software that are part of the programmed device.

Alternatively, said functions can be performed by a plurality of electronic devices over which the aforesaid functional modules can be distributed.

In general, the processing unit 4 can make use of one or more microprocessors or microcontrollers for performing the instructions contained in the memory modules and the aforementioned functional modules may also be distributed over a plurality calculators locally or remotely on the basis of the architecture of the network in which they reside.

The processing unit 4 first comprises a reading module 41, configured to receive as input the sports performance video.

The processing unit 4 includes a first recognition module 42, configured to identify in the video recording the playing area 5, i.e. the court. The court 5 is basically the background of the game, that is, what the system 1 considers fixed with respect to the players of the game, that is, the players 6′, 6″ and the ball 2, which/who instead move.

The system 1 then includes: a second recognition module 43, configured to identify and distinguish in the video one or more players 6′, 6″ from each other and a third recognition module 44, configured to identify and distinguish in the video one or more balls 2 from each other. A possible methodology for recognizing the ball 2 and the players 6′, 6″ will be illustrated later, when examples of possible embodiments of the invention will be described.

The processing unit 4 also includes a position module 45, configured to determine the positions of the players 6′, 6″ and of the ball 2; in detail, the position module 45 preferably determines the relative position of the players 6′, 6″ and of the ball 2, as identified by the recognition modules 42, 43, 44, with respect to the court 5 or to a reference system 1 integral to the court 5. The positions are characterized by two-dimensional or three-dimensional coordinates according to the number of detection devices 3 used. To be precise, the system 1 can also include a single electronic acquisition device 3 consisting of a camera, arranged for example at a fixed point with respect to the court 5 (see the example of FIG. 1). In this case, the aforementioned positions of the players 6′, 6″ and of the ball 2 are identified by two-dimensional coordinates. Otherwise, if at least two electronic acquisition devices are provided, these positions will be identified by three-dimensional coordinates.

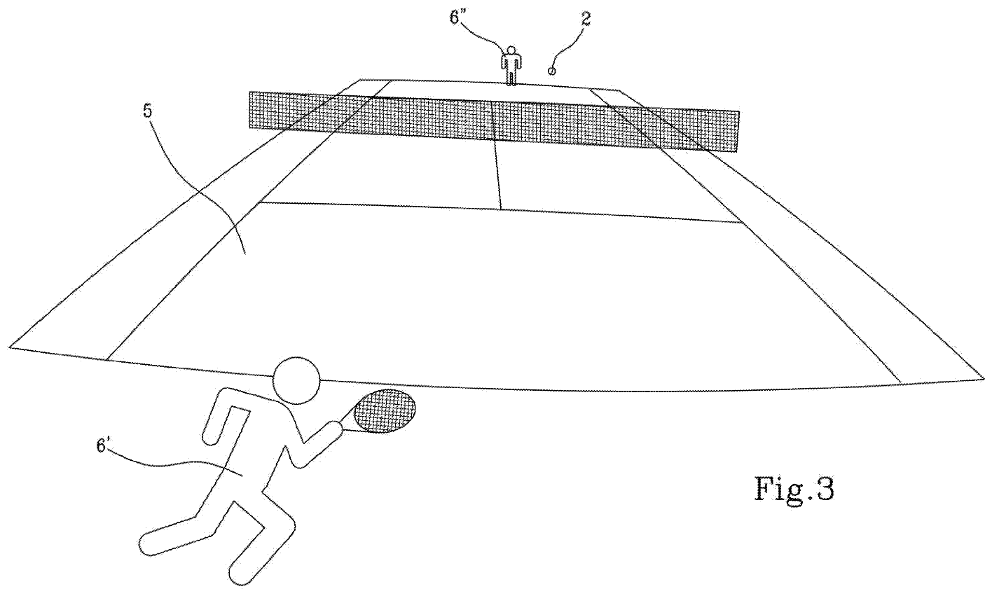

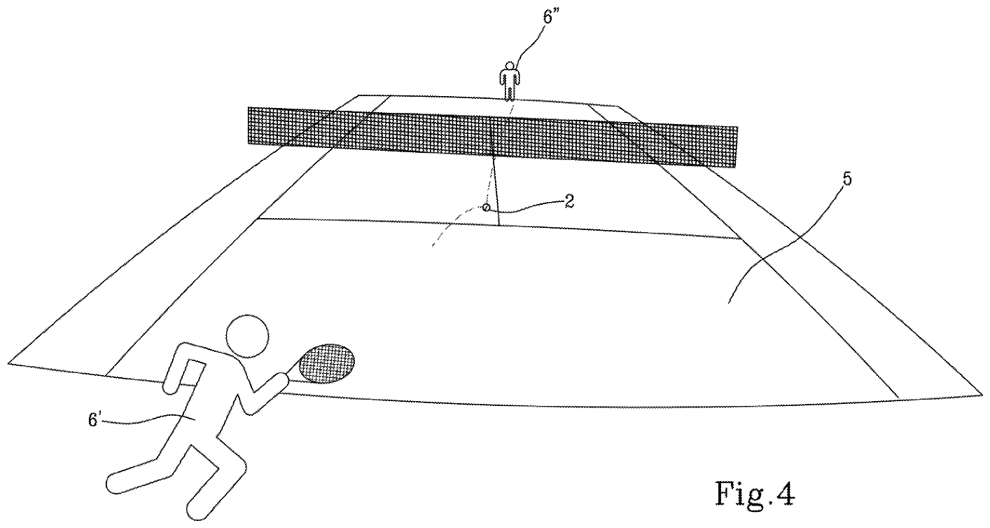

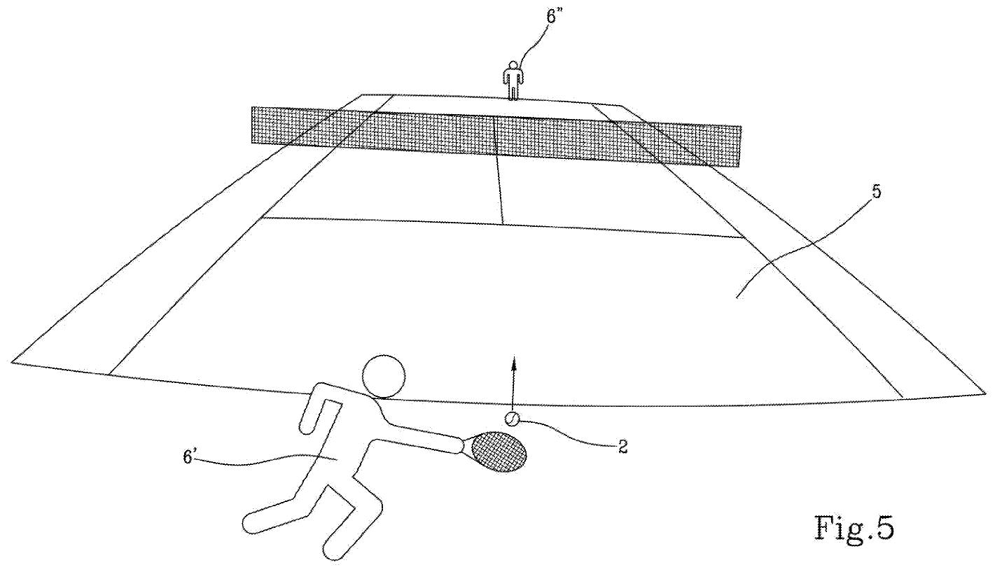

Once the players 6′, 6″ have been recognized and located and with them the balls 2 that are progressively used in the match, it is possible to follow and recognize the actions of the play The proposed system 1 therefore comprises a play scanning module 46, configured to identify in the video recording the fundamental playing events, such as for example a bouncing of a ball 2 (such as in FIG. 4) or a hitting of the ball 2 by a player (as shown in a stylized way in FIG. 5) or even the fact that the ball 2 hits the net. To be precise, it should be noted that the processing unit 4 performs the recognition and localization operations either for each frame or cyclically, that is, randomly on the basis of a predetermined period of time. Therefore, following the processing performed by the scanning module 46, in the aforementioned memory means or in a separate memory module 47, the processing unit 4 will record both the playing events and transition situations that occur between the playing events themselves (by way of example represented in FIG. 3) or in any case alongside them.

In practice, between the serve of a first player (FIG. 1) and the subsequent bounce of the ball 2 (FIG. 4) or after the backhand response of the second player and the subsequent event, the players of the game 6′, 6″ can move and in general will do so (see FIG. 3); therefore, the processing unit 4 will have intermediate situations available that do not constitute playing events but that can nevertheless be recorded for the post-processing step, as they potentially have an informative value themselves.

Intermediate situations follow a similar but distinct path compared to the events and use an ad hoc module to extract geometric and dynamic data.

Once the events and the intermediate situations have been identified, a time stamp is associated with them by a special stamping module 48 of the processing unit 4.

The events thus determined, also from the chronological point of view, are the basis from which it is possible to derive the prescriptive and predictive data referred to above.

The invention is then provided with a location module 49, configured to associate with each event the position of the players 6′, 6″ and the position of the ball 2 and also of an action module 401, configured to associate with each event one or more action parameters corresponding to relations between the players 6′, 6″ and between the players 6′, 6″ and the projectile 2, such as for example: distance between the two players 6′, 6″ or distance between each player 6′, 6″ and the ball 2.

In the preferred case where intermediate situations are also detected and recorded, then the scanning module 46 is configured to also identify such transition playing situations, the stamping module 48 will be configured to associate a time stamp with each identified transition situation; and the mentioned location module 49 will be configured to associate with each transition situation the position of the players 6′, 6″ and the position of the ball.

The aforementioned relations and the relative action parameters can be of a geometric type, as is the case exemplified in the upper paragraph or even of a dynamic type, that is relating to directions and speed.

To be precise, the processing unit 4 can comprise a movement module (not depicted), configured to determine the trajectories followed by the players 6′, 6″ and by the ball 2, on the basis of the change in their positions over time. In this case, the action parameters will correspond to the mentioned dynamic relations between the players 6′, 6″ and between the players 6′, 6″ and the ball 2, such as for example: speed of each player, speed of the projectile, direction of displacement of each player, direction of motion of the ball 2, etc. In this context, “trajectory” means the change in the position over time of the players of the game.

The proposed system 1 also includes a classification module 402, configured to associate with each event a respective playing action, as a function of the action parameters associated therewith, with respect to predetermined playing criteria, as well as a suspension module 403, configured to identify series of playing actions that impose the suspension of play, on the basis of a predefined playing rules.

In practice, in the case of tennis, which is the one considered herein by way of example, the playing actions can be a serve or a forehand response from a specific sector of the court 5 or a smash from a certain area near the net as well as the rebounds of the ball 2 that take place in the relative sectors of the court 5.

To recognize the actions, the processing unit 4 can include a memory module 47, not necessarily coinciding with or connected to the above-mentioned memory means, in which an exhaustive set of possible actions, i.e. action models, is recorded, employed by the play scanning module 46 to distinguish and identify the real events in the video recording. These models or prototypes of actions can in practice be constituted by respective defining rules, which take into account the position of the players 6′, 6″ and of the ball 2 and their reciprocal position, in predetermined instants or time stamps.

Several subsequent actions defined in this way, when they result in a suspension of the play, will constitute the series produced by the aforementioned suspension module 403; the playing rules are used for the definition of the series. For example, one can have a suspension of the play in the event of a foul play in the serve or at the same time as the score is updated.

In the case of tennis, the series are preferably composed of sets of two or sets of three actions and more generally of segments, formed by two or three successive actions. If the events are the atomic components, i.e. fundamental or irreducible, of the playing scan, the sets of two or sets of three thereof are the molecular components of the tennis match as analysed by the system 1 of the invention.

Note that it is also possible to make available additional modules provided to process the intermediate situations in a similar way to what happens with the events. In practice, the processing unit 4 may include:
an additional location module (not depicted), configured to associate with each intermediate situation the position of the players 6′, 6″ and the position of the ball 2;
a transition module (not depicted), configured to associate with each intermediate situation one or more transition parameters corresponding to relations between the players 6′, 6″ and between the players 6′, 6″ and the projectile; and
a cataloguing module (not depicted), configured to associate with each intermediate situation a respective type of transitional situation, as a function of the transition parameters associated therewith, with respect to predetermined evaluation criteria, for example the first player is late on a lob or the ball 2 has touched the net and therefore changes its original trajectory.

It is therefore clear that if such additional modules are provided, the processing of intermediate situations will be similar to that of the events, actions and segments.

The intermediate situations will interpose between the events, if detected by the additional modules, completing the parameters detected in different “time frames”.

The processing unit 4 then includes a segmentation module 404, configured to divide the series into two species of segments, on the basis of the number of strokes included in the relative sequence of actions, in accordance with the following rules:
if this sequence of actions contains at least two strokes, it constitutes a segment of the development of play; or
if the aforementioned sequence includes only one stroke, then it is a final segment, as in the case of these successions of actions: stroke-net (by “net” it is intended the case in which the ball 2 gets stuck in the net, as opposed to “let” that is when the ball 2 touches the net but passes beyond it) or stroke-bounce.

Each series always ends with a final segment, in the meaning defined above, after which the suspension module 403 intervenes, which proceeds to end the series with a possible update of the score.

Clearly, if a series is composed of only one segment, it is the final segment. Within the series or in the initial part thereof, in the event that the series is composed of more than one segment, the segments of the development of play are inserted.

For example, think of the following playing sequence: a first player 6″ serves from one side of the court 5 (action 1), the ball 2 bounces off a certain section or “quadrant” of the court 5 (action 2), and the second player 6′ replicates hitting the ball 2 with a forehand response (action 3); in this case, a first set of three actions has been defined (see FIGS. 2-5). The play carries on and, after the response of the second player (action 3), the ball 2 bounces out (action 4); the latter is the final segment of the series, which leads to the suspension of the play and therefore concludes this specific series. Note that the first action of the second set of two thereof coincides with the last action of the first set of three thereof.

One or more segments will then constitute a series.

Generally speaking, the segmentation module 404 is configured to divide the series of actions into one or more playing segments, each of which comprises three actions at most.

In a particular embodiment, the segmentation module 404 produces segments defined as follows:
the last segment of a series is always a set of two actions referring to the following two events: a stroke and a bounce; and
the remaining segments of the development of play are sets of two or three actions that always include two events corresponding to a respective stroke.

A particular case of series is the “score series”, that is the particular series in which the score changes, which is nothing more than a succession of subsequent segments interpreted on the basis of the possible actions with which the match develops and on the basis of the playing rules, which assigns a value to the aforementioned series in terms of score variation. This type of series is relevant for the evaluations concerning the efficacy of the sports performance, but it is not the only type of series identified and analysed by the processing unit 4.

The “database” referred to above includes all or part of the relevant data defined above: for each event, position of the players 6′, 6″ and of the ball 2 and relative instant, action parameters, type of action associated with each event, segment and series; in other words, the events are indexed on the basis of one or more of these relevant data.

In addition, the processing unit 4 comprises an interrogation module 405, configured to extract said data on the basis of the input requests; in this case, the processing unit 4 includes, or is connected to, a user interface 7, configured for the entry of the requests by the user.

Preferably, the processing unit 4 includes a collection module 406, configured to define schemes (or playing patterns) each comprising at least two segments with which specific action parameters are associated.

In detail, each segment that has the same specific action parameters defined as relevant is collected within the same pattern. The patterns are therefore playing segments that are repeated within the same series or in different series.

As highlighted above, each segment is formed by actions; the segments have as a first element a stroke; the second element of the segment is depending on the case a bounce or a net (set of two) or a hit on the fly; if the bounce is inside, a third element can possibly occur that is a stroke (defining a set of three). The first element of the set of two/three thereof thus identified is characterized by parameters or modules such as the type of stroke and the position from which it is hit; the second element is characterized by parameters such as the bounce zone. Based on this classification, families or types of segments are therefore created that can occur one or more times within the analysed period (a series, a game, a set, a match or in several aggregate matches). If there is only one occurrence of this type of segment, it will populate the database; if there are at least two occurrences, within the analysed period, there will be patterns.

For example, the scheme consists of: a first player serves from the left, the ball 2 bounces in a first zone of the second player's half court 5, the second player responds backhanded from a second zone. The pattern is identified by detecting a repetition of the same playing scheme at different times of the match(es); this repetition characterizes the pattern as “not random” but rather the result of a construction of the play that is repeated over time. Put the case of a player P1 who first serves from the right (“deuce”) of the court 5 on a given scoring situation. The first serve bounces within a zone 1 of the opponent's playing rectangle, with consequent forehand response of the player P2.

The segment just described is a segment that if it occurs at least twice within the analysed period (point, game, set, match, several aggregated matches) can therefore be defined as a playing scheme.

Put the following case of the forehand response inside by the player P2, with bounce in the zone of the court 5 B of the player P1 who hits the third forehand from a position C: the pattern previously identified and having as first element the first serve, is followed by a second pattern having as first element the forehand response of the player P2 and as second element the forehand response from a position C. If the succession of the first and second pattern occurs only once this occurrence will populate the database; if instead the succession of patterns 1 and 2 occurs at least twice, it will be referred to as a group or “cluster”.

In order to be able to understand which “patterns” are potentially significant and therefore worthy of analysis, the processing unit 4 can comprise a playing scheme efficacy module (not depicted), configured to couple to each pattern an efficacy value on the basis of the number of segments in which a predetermined player has scored and the total number of segments belonging to the pattern.

As reminded several times, a given segment is promoted to pattern status when it has at least two occurrences within the analysed period.

In the pattern efficacy module there are the following counters that operate on the aforementioned pattern:
counter of the number of occurrences,
counter of won/lost points or a detector of the number of points won/lost by the reference player.

In this regard, it is necessary to identify which patterns occur in the game with greater/lesser frequency, how many points such frequent/infrequent patterns contain and especially if the aforementioned patterns are relevant or efficacious for the progress of the match.

A percentage module (not represented) can be provided configured to calculate a quotient between the number of won/lost points and the number of occurrences with a given pattern; this defines the percentage rank among all identified patterns. The percentage module defines the positive efficacy of the pattern in case of percentage greater than 50%; likewise, the inefficacy of the pattern in case of percentage less than 50%.

At this point, to solve the cases of statistical insignificance given by a non-high denominator or to avoid the percentage module being the only element to identify the efficacy of the patterns, a weighting module (not represented) of the playing schemes introduces a ranking among playing patterns given by a mathematical formula that establishes a proportional method for the comparison of the numerousness of different pattern occurrences, but with very high/low percentage efficacy.

The weighting module of the playing schemes has the function of attributing a different weight to the different patterns having the same efficacy, if the following two cases are for example taken into account: 10/10=100% or 2/2=100%, it can be seen that both are 100% efficacious, but will have a different weighted value.

Preferably and by way of example only, in the event that a point has been scored in all segments of a specific pattern with respect to a predetermined player, then the respective weighted value will be calculated with an algebraic formula that will build a ranking among all patterns having the same efficacy.

The above weighting module helps to build a ranking of patterns used in the prescriptive step in order to select the most relevant information for the user. The processing unit 4 may also include an aggregation module (not depicted) configured to group at least two adjacent patterns at the temporal level. The combination of at least two patterns originates a cluster. The patterns can be different or the same. For example:
Pattern A0 (Stroke1-Bounce1-Stroke2)
Pattern A1 (Stroke2-Bounce2-Stroke3)

A Cluster X consists of Pattern A0 and of Pattern A1 or of Pattern A0 which is repeated twice.

In detail, the “cluster” consists of at least two patterns that have the same action in their inside and in this way are connected on a temporal level between them with a cause-effect relation.

If within the same cluster there are more than two patterns, these will give rise to a sequence of temporally continuous actions.

The “cluster” has the function of collecting the relevant data concerning a specific type of playing scheme, so as to be able to obtain the prescriptive and predictive information mentioned above several times.

In fact, once the multiple patterns are grouped into clusters, it can be inferred either how the same positive or negative result has been reached, for a predetermined player, or how a cluster recurs in producing a plurality of different results, which are relevant to judge the abilities of a player.

In practice, within a cluster, starting from a pattern that characterizes it, at least one other pattern develops with progressive and/or regressive ramifications.

For example, noting that the opponents of a certain player 6′, 6″ often lose a point by making a wrong backhand shot, when they are in certain quadrants of the court 5 it is possible to proceed backwards and, by analysing the schemes that preceded this situation, it can be detected that the circumstance in which the player 6′, 6 ″in question has shot backhanded cross-court from the bottom of the court 5 in reaction to a ball with a higher trajectory, occurs with a certain frequency, thereby identifying a type of playing scheme that constitutes a strong point of the player himself. Conversely, by analysing which schemes follow those in which the player 6′, 6″ serves from the left side of the court 5, it can be determined, for example, that the same player 6′, 6″ ends up often being in a sector of the court 5 where he is particularly susceptible to making mistakes on the shorter balls and from this to deduce some conditioning in the style of play that negatively affect the performance.

The group (or “cluster”) efficacy module is configured to calculate the frequency with which a pattern is related to one or more other patterns and determine whether this frequency is greater than one or more predetermined thresholds, this module allows to determine which scheme(s) depend on a specific temporally previous scheme.

The cluster efficacy module helps to build a ranking of clusters used in the prescriptive and predictive step in order to select the most relevant information for the user

The processing unit 4 may then include a cluster efficacy module (not depicted) configured to determine whether a predetermined cluster is a relevant or irrelevant cluster on the basis of the fact that its efficacy value and/or its proportion value and/or its base value is greater than a respective evaluation threshold. For example, if the result is lower than a threshold equal to 50% it can be defined as ineffective or if it is greater than that threshold it can be defined as efficacious.

As reminded several times, at least two adjacent patterns at the temporal level are promoted to cluster status when they have at least two occurrences within the analysed period.

The cluster efficacy module contains the following counters:
counter of the number of occurrences of the aforementioned cluster;
counter of points won/lost by the reference player when he practices the aforementioned cluster.

In this regard, it is necessary to identify which clusters occur in the play with greater/lesser frequency, how many points contain such frequent/infrequent clusters and especially if the aforementioned clusters are relevant or efficacious for the progress of the match.

It can be provided for a percentage module of the clusters (not depicted) given by the quotient between the number of won/lost points (numerator) and the number of the occurrences with a given cluster defines the percentage ranking among all the identified clusters. The percentage module defines the positive efficacy of the cluster in case of percentage greater than 50%; likewise, the inefficacy of the pattern in case of percentage less than 50%.

At this point, to solve the cases of statistical insignificance given by a non-high denominator or to avoid the percentage module being the only element to identify the efficacy of the clusters, a cluster weighting module introduces a ranking between playing clusters given by a mathematical formula that establishes a proportional method for the comparison of the numerousness of different cluster occurrences, but with very high/low percentage efficacy. The cluster weighting module has the function of attributing a different weight to the various clusters with the same efficacy, if the following two cases are for example taken into account: 10/10=100% or 2/2=100%, it can be seen that both are 100% efficacious, but will have a different weighted value.

In addition, the processing unit 4 may also comprise a translation module (not represented), configured to associate with relevant groups the respective playing suggestions, pre-recorded and predefined on the memory module. In this case, the user interface 7 is adapted to show the user such suggestions.

In other words, the translation module serves to provide the user with playing instructions corresponding to the most efficacious types of segments determined by the system 1 of the invention in a natural language.

Therefore, instead of a series of data, the user is provided with indications (which summarize the complex numerical data) such as: “From the left, serve on his forehand”, or “From the left, have him respond forehanded. So you're almost unbeatable!”

Thanks to these measures, the invention makes it possible to provide users with indications that are immediately understandable and implementable, possibly modulating the technical level of the information given on the basis of the type of target user, for example a coach of professional players or an amateur player.

The prescriptive module of the patterns transforms the messages generated by the efficacy/weighting module into a natural language as a “virtual coach” so as to provide indications on the patterns to be practiced, that is the efficacious behaviours to be maintained during a tennis match.

For example, if a pattern is efficacious, i.e. it returns weighted values greater than 50%, the pattern prescriptive module will provide messages in a natural language such as (see for example the playing pattern described above): “With the first serve from the right (on the x score) play in zone 1 on the forehanded response of Player P2 because with this pattern you (have):
played x number of points
won/lost y number of points
a percentage efficacy of z
a weighted efficacy of A.

The predictive module of the clusters (not represented) transforms the messages generated by the efficacy/weighting module into a natural language in order to provide indications on the clusters to be practiced, that is the efficacious behaviours to be maintained on the tennis court 5.

For example, if a cluster is efficacious, that is, it returns weighted values greater than 50%, the cluster predictive module will provide messages in a natural language such as (see, for example, the playing cluster described above): “With the first serve from the right (on the x score) play in zone 1 on the forehanded response of Player P2 because with this pattern you (have):
played x number of points
won/lost y number of points
a percentage efficacy of z
a weighted efficacy of A.

“If you play this first pattern (on the x score) there is an x probability that the Player P2 responds with this action and the following pattern occurs: forehand response in zone B because with this pattern you (have):
played x number of points
won/lost y number of points
a percentage efficacy of z
a weighted efficacy of A.

At this point, the cluster predictive module will end by recommending the next pattern to Player P1: “Play forehanded from position C on zone A” because with this pattern you (have):
played x number of points
won/lost y number of points
a percentage efficacy of z
a weighted efficacy of A.
   in practice, the combinations of patterns that originate the cluster will build relative predictions of possible scenarios (corresponding to “segments” in the sense indicated herein) that can occur during the match.

Possible modes of implementation of the proposed system 1 are described below, not limiting the embodiments included in the scope of the invention.

The aforementioned second and third recognition module 44, responsible for identifying and distinguishing the moving players of the game, i.e. the players 6′, 6″ and the ball 2, can employ a “background subtraction” method, such as the so-called “PIIB” as set out in the scientific publication “An adaptive parallel background model for high-throughput video applications and smart cameras embedding”, by V. Reno, R. Marani, T. D'Orazio, E. Stella, M. Nitti, discussed during the “International Conference on Distributed Smart Cameras” of 2014 in Venice, Italy.

In practice, the processing unit 4, for each image of the video recording subtracts the background, i.e. the fixed part of the shooting, which is known, to obtain the moving subjects 6′, 6″.

Based on predetermined shape patterns, defective or unsatisfactory occurrences of the moving subjects 6′, 6″ can be detected through a difference, using a voting procedure. As far as the recognition of the ball 2 is concerned, the candidate shooting areas can be checked with a circularity test, using for example the Hough transform. As for the areas of the image that are candidates to be identified as players 6′, 6″, they are selected on the basis of the size and asymmetry of the relative main axis. The shadows are removed from the candidate area by means of a colour analysis and in the remaining area the silhouette of the player is identified.

In order for the movement module to be able to calculate the trajectories of the ball 2 and of the players 6′, 6″ it is preliminarily necessary, for the former, that a circularity check is performed so that the centre of gravity can then be determined and, for the latter, that the asymmetry and, also on the basis of the silhouette, the respective centre of gravity are determined.

In detail, when the movement module causes a reversal of the direction of the ball 2, then the aforementioned play scanning module 46 may infer that it has been kicked back by a player's racket. Since the processing unit 4 knows the position of the court 5, which is fixed, a play scanning module 46 can then determine from the trajectory of the ball 2 when it bounces and where it bounced.

This information is the basis for determining the actions corresponding to the events and is also used by the suspension module 403 to determine whether the score should be updated. To be precise, this information, combined with the reciprocal position between players 6′, 6″, ball 2 and court 5, define the action parameters already discussed above, allowing the classification module 402 to establish the playing action, for example: serve, smash, volley, lob, etc . . . .

The user interface 7 can make use of videos, either in augmented reality or virtual reality to provide the user with prescriptive or predictive indications, through a selection of the salient moments, or “highlights”, which represent the relevant “clusters”, i.e. those including efficacious series, possibly associating with them, in overprint, the efficacy, proportion or basic values or the indications in a natural language referred to above.

1. A system (1) for acquiring and analysing a sports performance comprising at least one electronic processing unit (4) comprising a reading module (41), configured to receive as input a succession of data associated with the execution of said sports performance;
a suspension module (403) configured to identify series of actions that conclude with the suspension of play, on the basis of predefined playing rules, where every playing action is defined at least by the reciprocal relations between the players (6′, 6)″ and the playing projectile (2) coupled with fundamental playing events marking the sports performance, uniquely identified over time and derived from said acquired succession of data;
a segmentation module (404) configured to divide said series of actions into one or more playing segments, each of which comprises three actions at most.

2. The system (1) according to claim 1, comprising at least one electronic acquisition device (3) connected to said processing unit (4) and adapted to transmit thereto the aforementioned succession of data associated with the execution of the sports performance;
wherein the processing unit (4) comprises:
a first recognition module (42), configured to determine a playing area;
a second recognition module (43), configured to identify and distinguish one or more players (6′, 6″) from each other;
a third recognition module (44), configured to identify and distinguish a playing projectile (2);
a position module (45), configured to determine positions of the players (6′, 6″) and of the projectile (2);
a play scanning module (46), configured to identify the aforesaid fundamental playing events;
a stamping module (48), configured to associate a time stamp with each event;
a location module (49), configured to associate with each event the position of the players (6′, 6″) and the position of the playing projectile (2);
an action module (401), configured to associate with each event one or more action parameters corresponding to relations between the players (6′, 6″) and between the players (6′, 6″) and the projectile (2);
a classification module (402), configured to associate with each event the respective playing action, on the basis of the action parameters associated therewith, compared to predetermined playing criteria.

3. The system (1) according to claim 2, wherein said acquisition device is a camera (3) that transmits to the aforementioned reading module a succession of data defined by one or more videos and wherein the aforesaid first recognition module (42) is configured to determine the playing area (5) in the aforementioned video; the second recognition module (43) is configured to identify and distinguish the players (6′, 6″) in the video; the third recognition module (44) is configured to identify and distinguish the aforesaid playing projectile (2); and the play scanning module (46), is configured to identify the aforesaid fundamental playing events in the video.

4. The system (1) according to claim 1, wherein said processing unit (4) comprises a movement module, configured to determine trajectories followed by the players (6′, 6″) and by the projectile (2), on the basis of the change in said positions over time; said action parameters also corresponding to dynamic relations between the players (6′, 6″) and between the players (6′, 6″) and the projectile (2).

5. The system (1) according to claim 1, wherein the processing unit (4) includes at least one memory module (47) in which data related to the aforesaid events, indexed at least on the basis of said action parameters, are recorded, wherein the processing unit (4) comprises an interrogation module (405), configured to extract said data on the basis of input requests and wherein the processing unit (4) includes or is connected to a user interface (7), configured for the entry of said requests by a user.

6. The system according to claim 2, wherein said scanning module (46) is configured also to identify situations of transition in play that occur between the aforementioned events; wherein said stamping module (48) is configured to associate a time stamp with every transition situation identified; wherein said location module (49) is configured to associate the position of the players (6′, 6″) and the position of the playing projectile (2) with each transition situation.

7. The system according to claim 5, wherein data related to intermediate situations are also recorded in the memory module (47), said interrogation module (405) being configured also to extract said data.

8. The system (1) according to claim 1, comprising a single electronic acquisition device consisting of a camera (3), wherein said positions of the players (6′, 6″) and of the playing projectile (2) are identified by two-dimensional coordinates.

9. The system (1) according to claim 1, wherein the segmentation module (404) is configured to define successive segments and wherein the last action of one segment corresponds to the first of the next segment.

10. The system (1) according to claim 1, wherein the sports performance is a tennis performance and the segmentation module (404) produces segments thus defined:
the last segment of a series is always a pair of actions referring to the following two events: a stroke and a bounce; and
the remaining segments of the development of play are sets of two or three actions that always include two events corresponding to a respective stroke.

11. The system (1) according to claim 1, wherein the processing unit (4) comprises a segment gathering module (406) configured to define playing schemes, each of which comprises at least two segments with which the same predefined action parameters are associated.

12. The system (1) according to claim 11, wherein the processing unit (4) includes a scheme efficacy module configured to couple an efficacy value to each scheme.

13. The system (1) according to claim 12, wherein the processing unit (4) includes a weighting module configured to attribute a different weight to schemes having a same efficacy, on the basis of a respective statistical significance, in order to define a hierarchy of efficacy thereof.

14. The system (1) according to claim 11, wherein said processing unit (4) comprises an aggregation module configured to group at least one plurality of schemes into respective groups.

15. The system (1) according to claim 14, wherein the aggregation module is configured to group at least one plurality of schemes linked to each another in a temporally continuous manner into respective groups.

16. The system (1) according to claim 15, wherein said processing unit (4) comprises a group efficacy module configured to couple an efficacy value to each group.

17. The system (1) according to claim 9, wherein said processing unit (4) comprises a translation module to provide the user with playing instructions corresponding to the most efficacious types of segments determined by the system (1) of the invention in a natural language.

18. The system (1) according to claim 3, comprising at least two electronic acquisition devices 3, each consisting of a camera, wherein said positions of the players (6′, 6″) and of the playing projectile (2) are identified by three-dimensional coordinates.
